(19) United States
(12) Patent Application Publication
(10) Pub. No.: US 2006/0157545 A1
(43) Pub. Date: Jul. 20, 2006

(54) Returnable carton for bottles

(76) Inventor: Jean-Michel Auclair, Chateauroux (FR)

Correspondence Address: MEADWESTVACO CORPORATION;LAW DEPARTMENT, 4850 NORTH CHURCH LANE, SUITE D, SMYRNA, GA, 30080, US

(21) Appl. No.: 11/301,478

(22) Filed: Dec. 12, 2005

Related U.S. Application Data
(63) Continuation of application No. PCT/US04/18721, filed on Jun. 10, 2004.

(30) Foreign Application Priority Data
Jun. 10, 2003 (GB) 3013341.0

(51) Int. Cl. B26D 5/42; B65D 17/00

(52) U.S. Cl. 229/103.2; 229/198.2; 229/221

(57) ABSTRACT

A carton for returnable containers includes at least a top wall panel, a base wall panel and a pair of side wall panels connecting together the top and base wall panels to form a tubular structure in which a plurality of containers are accommodated. One of the wall panels is formed with a tear-away strip the removal of which separates that panel into two detached portions and which allows the carton to be separated entirely from its contents. The carton further includes detached portion-reconnecting means that includes a hinged flap and a locking aperture. The hinged flap is partially detachable from the one wall panel adjacent one edge of the tear-away strip and foldable into overlapping relationship with the one wall panel adjacent an opposite edge of the tear-away strip. The hinged flap has a locking tab and the locking aperture is defined in the one wall panel adjacent the opposite edge of the tear-away strip to receive the locking tab so that the detached portions may be reconnected together after removal of the tear-away strip in order to reconstruct the carton.

This is a continuation of international application No. PCT/US2004/018721, filed Jun. 10, 2004, which is hereby incorporated by reference.

### BACKGROUND OF THE INVENTION

This invention relates to a carton, and its blank, for returnable containers, such as bottles, and particularly, although not exclusively, to wrap-around type cartons.

Cartons having some reclosable function are well known in the art. For example, U.S. Pat. No. 4,417,661 (Raccaforte) discloses a reclosable carton comprising a tear open means (48) which detachably interconnects first and second parts (46), (22 and 24) of the carton. The first part (46) comprises a connector flap (60) formed therefrom for re-connecting the first and second parts after the tear open means (48) is broken.

However, in the present invention, a tear open means allows the carton to be completely detached from its contents and renders the carton into two separate parts. Each of the separate parts is furnished with complementary connecting means by which the carton can be reconstructed after being filled with empty bottles so that it can be returned as a unit to a point of sale.

U.S. Pat. No. 5,443,203 (Sutherland) discloses a carton locking arrangement in a wraparound type carton in which an engaging tab (42) is formed from a flap body (26) to which a distal end portion (36) is hingedly connected along a fold line (38). However, the locking arrangement of Sutherland is not presented in the context of a re-constructible carton for returnable containers.

U.S. Pat. No. 2,554,098 (Bamber) discloses panel connecting flaps (7, 14, 15) in a carton which are formed from a part of the carton and folded 180° to have their respective distal end portions engaged with another part of the carton. However, the panel-connecting flaps of Bamber are not presented in the context of a re-constructible carton for returnable containers.

### SUMMARY OF THE INVENTION

One aspect of the present invention provides a carton for returnable containers, such as bottles, which carton includes at least a top wall panel, a base wall panel and a pair of side wall panels, connecting together the top and base wall panels, to form a tubular structure in which a plurality of containers can be accommodated in a unit, and wherein one of the wall panels is formed with a tear-away strip, the removal of which separates that panel into two detached portions and which allows the carton to be separated entirely from its contents, characterized in that complementary connecting means are provided in each of the detachable portions, and wherein said complementary connecting means can be deployed to reconnect the two detached detachable portions after the carton has been repackaged with containers after use to provide a reconstructed carton for return of the containers to a point of sale. Preferably, the complementary connecting means comprises a hinged flap partially detachable from a wall panel adjacent one edge of the tear-away strip and foldable into overlapping relationship with a wall panel adjacent an opposite edge of the tear-away strip, complementary locking means being provided by said hinged flap and the wall panel adjacent said opposite edge of the tear-away strip and by that wall panel to connect together the adjacent wall panels after removal of the tear-away strip.

In some circumstances where the complementary connecting means comprises a hinged flap, the complementary locking means may comprise a locking tab provided by said hinged flap and a locking aperture provided in the wall panel adjacent said opposite edge of the tear-away strip to receive the locking tab in locking engagement thereby to connect together the detached wall panels when the hinged flap bridges the adjacent detached edges of said wall panels. Where a locking tab is provided, it may be struck from the hinged flap and may be hinged thereto along a fold line extending across the hinged flap.

In some other optional constructions a plurality of locking tabs may be struck from the hinged flap, each such locking tab being hinged to its hinged flap along one of said fold lines, there being one complementary locking aperture for each locking tab.

In either of the constructions where one or more locking tabs are provided, a plurality of hinged flaps also may be provided by said wall panel.

According to another feature of this aspect of the invention, the complementary locking means and the tear-away strip may be provided in one and the same wall panel. Preferably, the carton is a wrap-around type carton.

Another aspect of the invention provides a carton blank which can be manipulated to provide a carton for accommodating returnable containers, such as bottles, which blank comprises a first base panel, a first side wall panel, a top panel, a second side wall panel and a second base panel connected one to the next in series and wherein one of the wall panels is formed with a tear-away strip the removal of which separates that wall panel and the blank into two detached portions, characterized in that complementary connecting means are provided in each of the detachable wall panel portions, which complementary connecting means can be deployed to reconnect said two detachable portions.

According to a feature of this aspect of the invention, the complementary connecting means may be provided in one and the same wall panel of the blank on either side of the tear-away strip in that wall panel.

### BRIEF DESCRIPTION OF THE DRAWINGS

Exemplary embodiments of the invention will now be described, by way of example, with reference to the accompanying drawings in which:

FIG. 1 is a plan view of a paperboard blank for forming a wraparound type carton according to a first embodiment of the invention;

FIG. 2 is a perspective view of a filled wraparound type carton formed from the blank shown in FIG. 1;

FIG. 3 is a perspective view of the carton of FIG. 2 which has been opened for removal of the carton from its contents;

FIG. 4 is a perspective view of the arrangement of FIG. 3, in which the carton has been refilled with empty bottles for return and a hinged flap is being partially separated from the adjacent side wall panel;

FIG. 5 is a perspective view of the carton of FIG. 4, in which the hinged flap has been deployed to re-construct the carton into a coherent unit;

FIG. 6 is a plan view of a paperboard blank for forming a wraparound type carton which has end closure panels and complementary connecting means according to another embodiment of the invention;

FIG. 7 is a perspective view of a filled wraparound type carton formed from the blank shown in FIG. 6;

FIG. 8 is a perspective view of the carton of FIG. 7 which has been opened for removal of the carton from its contents;

FIG. 9 is a perspective view of the arrangement of FIG. 8, in which the carton has been refilled with empty bottles for return and hinged flaps are being partially separated from the adjacent side wall panel; and

FIG. 10 is a perspective view of the carton of FIG. 9, in which the hinged flaps have been deployed to re-construct the carton into a coherent unit.

### DETAILED DESCRIPTION OF THE PREFERRED EMBODIMENTS

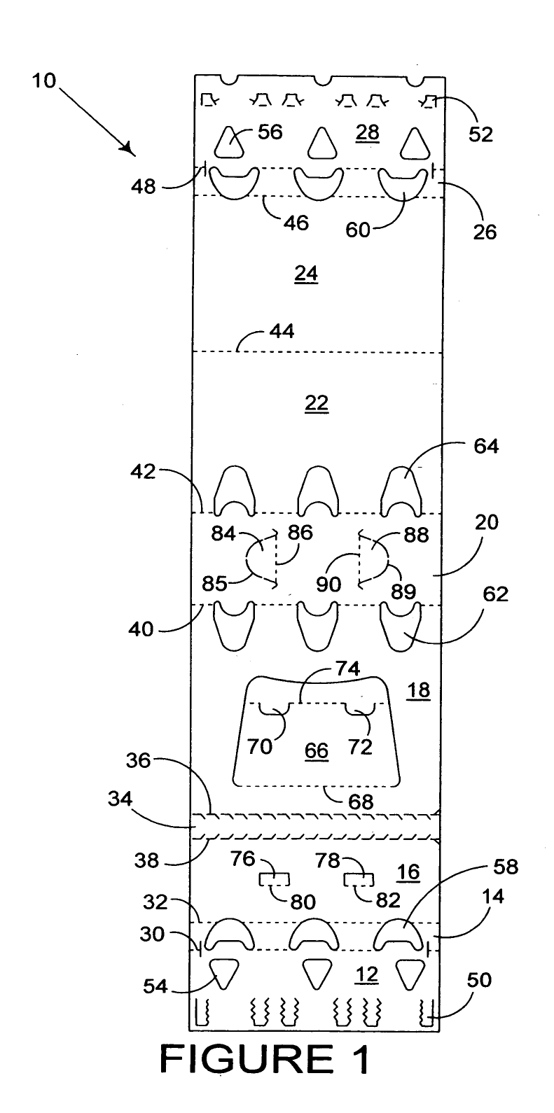

Referring to FIG. 1 of the drawings, there is shown a carton blank 10 for forming a wraparound type carton made from paperboard or sheet material performing a like function. The blank 10 comprises a plurality of panels for forming a top, base and opposed sides. In this embodiment there comprises a first base panel 12, a heel panel 14, a lower side wall panel 16, an upper side wall panel 18, a top panel 20, a second upper side panel 22, a second lower side wall panel 24, a second heel panel 26 and a second base panel 28 hinged one to the next along fold lines 30, 32, tear-away strip 34, fold lines 40, 42, 44, 46 and 48 respectively.

The first base panel 12 is formed with a series of known locking tabs 50 which cooperate with complementary locking apertures defined by locking flaps 52 struck from the second base panel 28.

In order to draw the base panels 12 and 28 into overlapping relationship to engage the complementary locking elements 50 and 52, the base panels are formed with openings 54 and 56 which are engaged by machine elements for tightening the base panels towards one another.

The heel panel 14, which takes on a beveled configuration when the carton is set up, is formed with openings 58 which receive portions of the heel of a bottle retained within the carton. Similar heel apertures 60 are formed in the heel panel 26.

Further openings 62 and 64 are provided partly in the top wall 20 and partly in each of the other side walls 18 and 22 in order to receive neck portions of the bottles to be received in the carton.

The upper side wall 18 is formed with a hinged flap 66 which is struck from upper side wall 18 and hinged thereto along a fold line 68. The hinged flap is provided with a pair of locking tabs 70 and 72 which are struck from the hinged flap and foldably joined thereto along fold line 74.

Complementary locking apertures are provided in the lower side wall 16 which are defined by locking flaps 76 and 78 hinged to the side wall panel 16 along fold lines 80 and 82.

The top wall is provided with flap 84 and 88 which define openings 85 and 89 respectively by which the carton can be lifted. The flaps 84 and 88 are hinged to the top wall about fold lines 86 and 90 respectively.

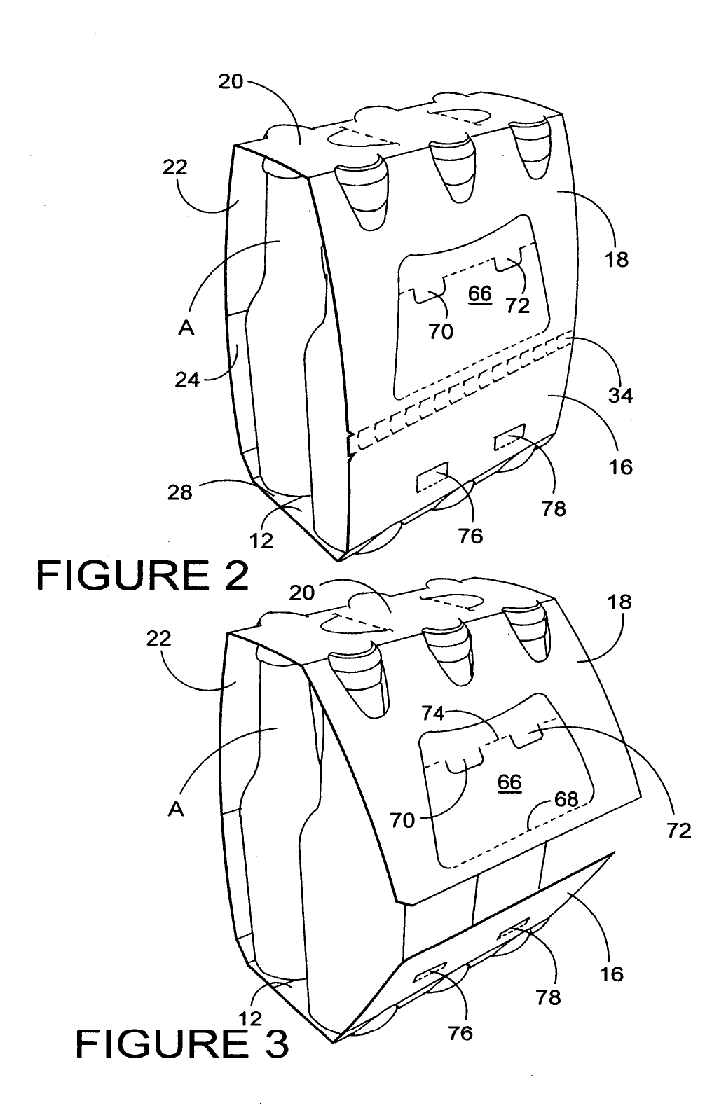

FIG. 2 shows the blank wrapped around a group of six bottles and the base panels 12 and 28 secured in overlapping relationship. In order to open the carton the tear-away strip 34 is torn from the carton thus separating the lower side wall panel 16 from the upper side wall panel 18 so that the blank can be entirely removed and detached from the bottles.

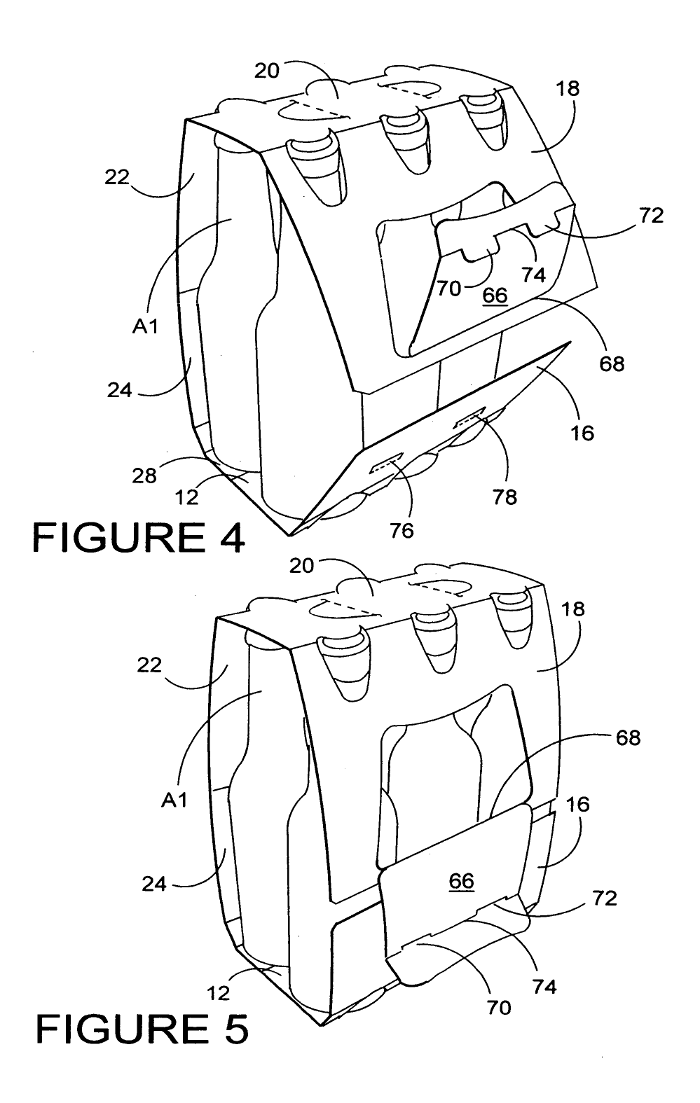

When the contents of the bottles have been used, the bottles can be returned by once again applying the wraparound carton to the group of six empty bottles as shown in FIG. 4. The carton blank can then be manipulated so as to reconstruct the carton. This is done by hinging down the hinge flap 66 about fold line 68 and causing the locking tabs 70 and 72 to be inserted into locking engagement with the locking apertures defined by tabs 76 and 78 in the adjacent panel 16. The reconstructed carton accommodating empty bottles for return to the point of sale is shown in FIG. 5 of the drawings.

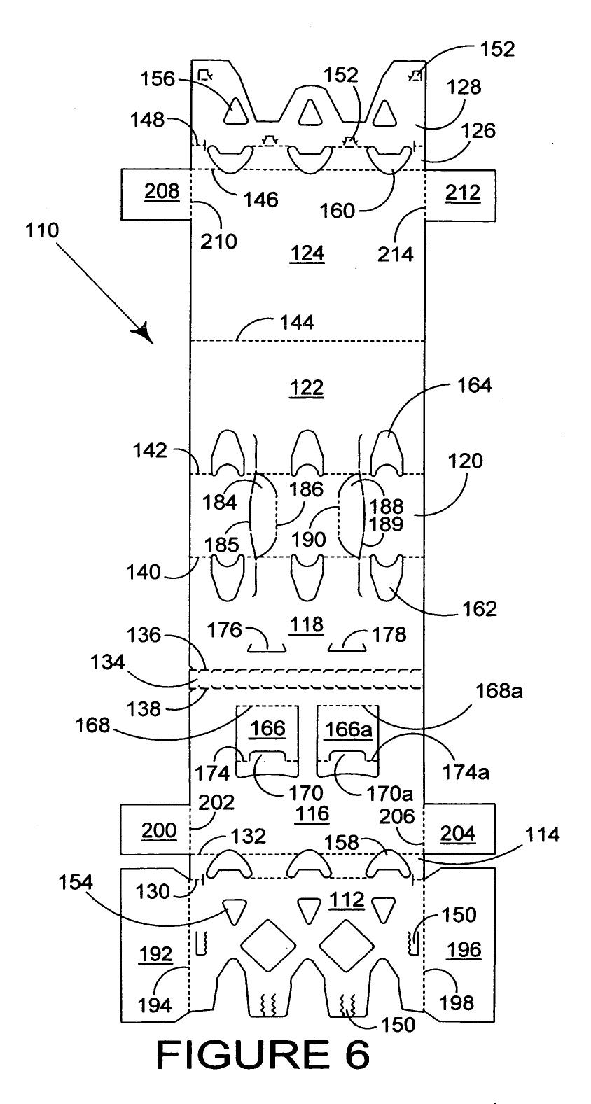

Referring now to FIGS. 6 to 10 of the drawings a second embodiment of the invention is shown in which like parts have like reference numerals. The most significant difference in relation to the carton shown in the second embodiment of the invention is that instead of being a wraparound carton with completely open ends the ends of the wraparound carton in the second embodiment are partially closed by end closure panels such as panel 192. Moreover, in this particular embodiment, instead of having a single hinge flap with a plurality of locking tabs, the lower side panel 116 is struck with two hinge flaps 166 and 166a each provided with its own locking tab 170, 170a which are sized to be received in complementary locking apertures at 176 and 178 in lower panel 118.

The end closure structures are provided by panels 192 and 196 each hinged to opposite sides of the base panel 112 and also by side end closure panels 200 and 204 hinged to opposite edges of lower side wall panel 116. Further side end closure panels 208, 212 are hinged on opposite side of lower side wall panel 124.

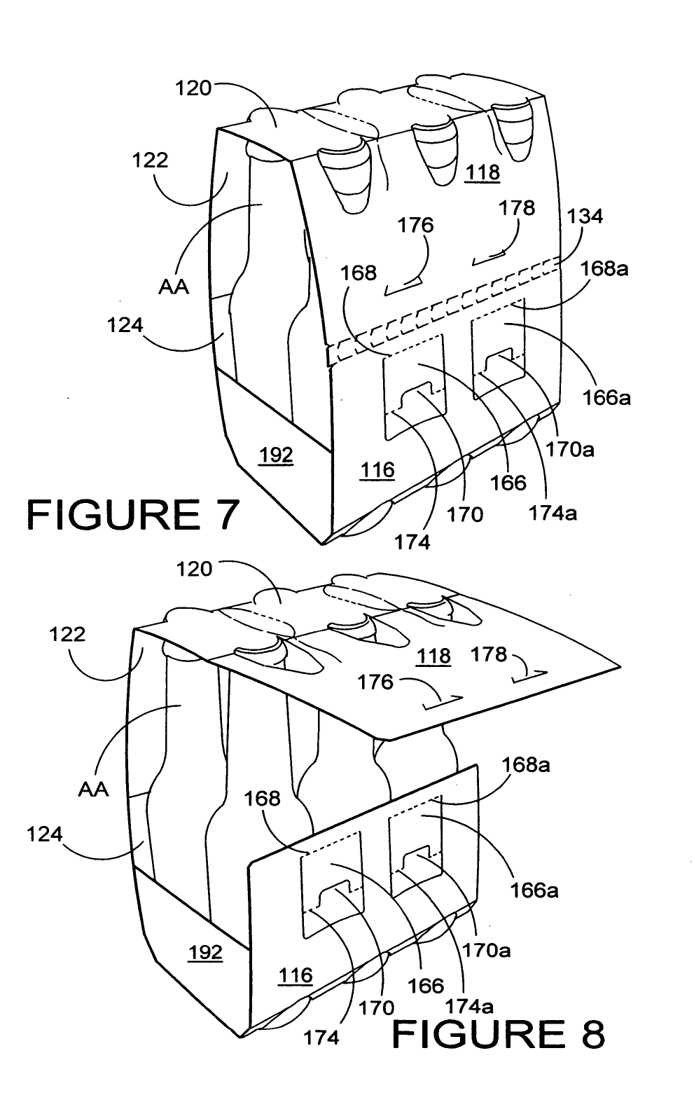

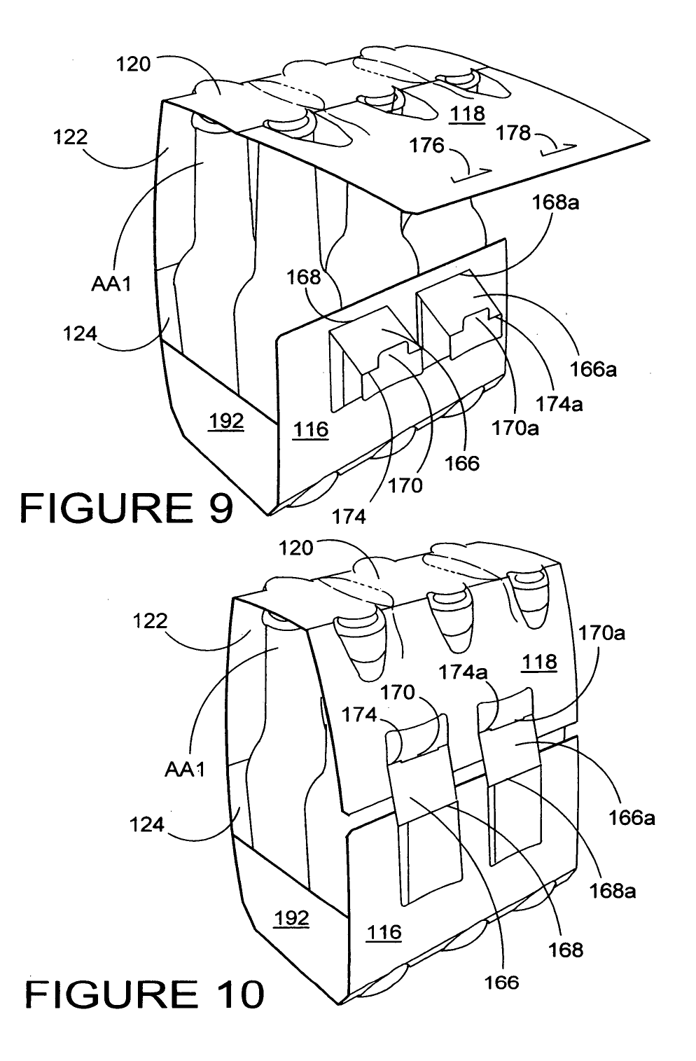

As with the first embodiment, FIG. 7 shows the blank being applied to a group of six bottles and enclosed to provide the completed carton whereas FIG. 8 shows the tear-away strip 134 removed in order to detach the blank separated from the bottle group. FIG. 9 shows empty bottles being enclosed in the blank for securement in order to create the reconstructed carton shown in FIG. 10 of the drawings.

The present invention and its preferred embodiments relate to an arrangement for providing a reclosable access structure in a fully enclosed carton. However, it is anticipated that the invention can be applied to a variety of carriers and is not limited to those of the fully enclosed type hereinbefore described and could be used for numerous applications for example a wraparound carton.

It will be recognised that as used herein, directional references such as “top”, “base”, “end”, “side”, “inner”, “outer”, “upper” and “lower” do not limit the respective panels to such orientation, but merely serve to distinguish these panels from one another. Any reference to hinged connection should not be construed as necessarily referring to a single fold line only: indeed it is envisaged that hinged connection can be formed from one or more of one of the following, a score line, a frangible line or a fold line, without departing from the scope of invention.

It should be understood that various changes may be made within the scope of the present invention, for example, the size and shape of the panels and apertures may be adjusted to accommodate articles of differing size or shape, alternative top and base closure structures may be used. The carton may accommodate more than one article in different arrays.

What is claimed is:

1. A carton for returnable containers, comprising at least a top wall panel, a base: wall panel and a pair of side wall panels, connecting together the top and base wall panels to form a tubular structure in which a plurality of containers can be accommodated in a unit, wherein one of the wall panels is formed with a tear-away strip for removal from the carton such that the removal of the tear-away strip separates said one wall panel into two detached portions and the removal allows the carton to be separated entirely from its contents, wherein complementary connecting means are provided in each of the detached portions, and wherein said complementary connecting means is capable of being deployed to reconnect the two detached portions after the carton has been repackaged with containers after use to provide a reconstructed carton for return of the containers to a point of sale.

2. A carton according to claim 1 wherein the complementary connecting means comprises a hinged flap partially detachable from said one wall panel adjacent one edge of the tear-away strip and foldable into overlapping relationship with said one wall panel adjacent an opposite edge of the tear-away strip, and at least one locking aperture defined in said one wall panel adjacent said opposite edge of the tear-away strip.

3. A carton according to claim 2 wherein the hinged flap comprises at least one locking tab, and at least one locking aperture is provided to receive the at least one locking tab in locking engagement so that the hinged flap bridges the detached portions of said one wall panels to connect together the detached portions.

4. A carton according to claim 3 wherein the at least one locking tab is struck from the hinged flap and joined to a foldable marginal portion of the hinged flap, wherein the foldable marginal portion is hinged to the remainder of the hinged flap along a fold line extending across the hinged flap.

5. A carton according to claim 4 wherein said hinged flap comprises a plurality of said locking tabs struck from the hinged flap, each of the locking tabs being hinged to the hinged flap through said marginal portion, said one wall panel having a plurality of said locking apertures for receiving said locking tabs respectively.

6. A carton according to claim 3 wherein said one wall panel has a plurality of said hinged flaps.

7. A carton according to claim 1 wherein the complementary connecting means and the tear-away strip are provided in said one wall panel.

8. A carton according to claim 1 wherein the carton is of an open-ended tubular structure.

9. A carton blank for forming a tubular carton for accommodating returnable containers, the blank comprising a first base wall panel, a first side wall panel, a top wall panel, a second side wall panel and a second base wall panel connected one to the next in series, wherein one of the wall panels is formed with a tear-away strip for removal from the blank such that the removal of the tear-away strip separates said one wall panel into two detached portions, and wherein complementary connecting means are provided in each of the detached portions, the complementary connecting means is capable of being deployed to reconnect said two detached portions.

10. A carton blank according to claim 9 wherein the complementary connecting means are provided in said one panel of the blank on either side of the tear-away strip.
